(19) United States
(12) Patent Application Publication
(10) Pub. No.: US 2017/0121210 A1
(43) Pub. Date: May 4, 2017

(54) METHOD AND APPARATUS FOR SHAPING A 3D GLASS-BASED ARTICLE

(71) Applicant: CORNING INCORPORTED, CORNING, NY (US)

(72) Inventors: Rohit Rai, Painted Post, NY (US); John Richard Ridge, Hammondsport, NY (US); Ljerka Ukrainczyk, Painted Post, NY (US)

(21) Appl. No.: 15/335,669

(22) Filed: Oct. 27, 2016

Related U.S. Application Data
(60) Provisional application No. 62/248,496, filed on Oct. 30, 2015.

(51) Int. Cl. C03B 23/035

(52) U.S. Cl. CPC C03B 23/0355; C03B 23/0357

(57) ABSTRACT

A method of shaping a glass-based substrate including placing a glass-based substrate on a mold having a mold surface with a 3D surface profile, heating the glass-based substrate to a shaping temperature, creating a sealed environment above the glass-based substrate, and adjusting the pressure in the sealed environment with a pressurized gas to conform the glass-based substrate to the profile of the mold surface to create a shaped glass-based article. The shaped glass-based article may be free of distortions having a height to width ratio greater than 2×10⁻⁴.

### CROSS-REFERENCE TO RELATED APPLICATIONS

This application claims the benefit of priority under 35 U.S.C. §119 of U.S. Provisional Application Ser. No. 62/248496 filed on Oct. 30, 2015, the content of which is relied upon and incorporated herein by reference in its entirety.

### TECHNICAL FIELD

The present invention relates generally to a method and apparatus for thermally reforming two-dimensional (2D) glass-based sheets into three-dimensional (3D) glass-based articles and article formed therefrom.

### BACKGROUND

There is a large demand for 3D glass covers for portable electronic devices such as laptops, tablets, and smart phones. A particularly desirable 3D glass cover has a combination of a 2D surface, for interaction with a display, and a 3D surface, for wrapping around the edge of the display. The 3D surface may be an undevelopable surface, i.e., a surface that cannot be unfolded or unrolled onto a plane without distortion, and may include any combination of bends, corners, and curves. The bends may be tight and steep. The curves may be irregular. Such 3D glass covers are complex and difficult to make with precision.

Thermal reforming has been used to form 3D glass articles from 2D glass sheets. Thermal reforming involves heating a 2D glass sheet to a forming temperature and then reforming the 2D glass sheet into a 3D shape. Where the reforming is done by sagging (e.g. relying on vacuum or gravity) or pressing the 2D glass sheet against a mold, it is desirable to keep the temperature of the glass below the softening point of the glass to maintain a good glass surface quality and to avoid a reaction between the glass and the mold. Below the softening point, the glass has a high viscosity and requires a high pressure to be reformed into complex shapes such as bends, corners, and curves. In traditional glass thermal reforming a plunger is used to apply the needed high pressure. The plunger contacts the glass and presses the glass against the mold.

To achieve a 3D glass article with a uniform thickness, the gap between the plunger surface and the mold surface must be uniform while the plunger presses the glass against the mold. FIG. 1A shows an example of a uniform gap between a plunger surface 100 and a mold surface 102. However, it is usually the case that the gap between the plunger surface and the mold surface is not uniform due to small errors in mold machining and alignment errors between the mold and plunger. FIG. 1B shows a non-uniform gap (e.g., at 103) between the plunger surface 100 and mold surface 102 due to misalignment of the plunger with the mold. FIG. 1C shows a non-uniform gap (e.g., at 105) between the plunger surface 100 and mold surface 102 due to machining errors in the mold surface 102.

Non-uniform gaps result in over-pressing in some areas of the glass and under-pressing in other areas of the glass. Over-pressing will create glass thinning that will show up as a noticeable optical distortion in the 3D glass article. Under-pressing will create wrinkles in the 3D glass article, particularly at complex areas of the glass article including bends, corners, and curves. Small machining errors, e.g., on the order of 10 microns, can result in non-uniform gaps that would produce over-pressing and/or under-pressing. Unavoidable thermal expansion of the plunger surface, mold surface, glass, or other equipment involved in the forming can also affect uniformity of the gap.

During pressing, the plunger also stretches the glass so that the thickness of the glass between the plunger surface and mold surface changes. Therefore, even if the gap between the plunger surface and the mold surface are perfect, the stretching of the glass would result in a 3D glass article having a non-uniform thickness. The mold surface or the plunger surface may be designed to compensate for the expected change in glass thickness as a result of stretching. However, this will result in a non-uniform gap between the plunger surface and mold surface, which as noted above will result in over-pressing in some areas of the glass and under-pressing in other areas of the glass.

### SUMMARY

In a first aspect, a method of shaping a glass-based substrate includes placing a glass-based substrate on a mold having a mold surface with a 3D surface profile; heating the glass-based substrate to a shaping temperature; creating a sealed environment above the glass-based substrate; and adjusting the pressure in the sealed environment with a pressurized gas to conform the glass-based substrate to the profile of the mold surface to create a shaped glass-based article. The shaped glass-based article may be free of distortions having a height to width ratio greater than 2×10 ⁻⁴.

A second aspect according to the first aspect, wherein creating the sealed environment comprises placing a pressure cap assembly over the mold, wherein the pressure cap includes an orifice for supplying the pressurized gas and a baffle positioned over the orifice to direct the flow of the gas.

A third aspect according to the second aspect wherein the method also includes heating the pressure cap assembly to radiatively heat the glass-based substrate.

A fourth aspect according to the second or third aspect, wherein the temperature of the pressure cap is higher than the temperature of the mold surface.

A fifth aspect according to the fourth aspect, wherein a temperature difference between the pressure cap and the mold surface is in a range from about 20° C. to about 150° C.

A sixth aspect according to any one of the second through fifth aspects, wherein there is only a single orifice in the pressure cap.

A seventh aspect according to any one of the first through sixth aspects, wherein the pressurized gas is heated.

An eighth aspect according to any one of the first through seventh aspects, wherein the sealed environment is adjusted to a pressure in a range from about 20 psi to about 60 psi.

A ninth aspect according to any one of the first through eighth aspects, wherein the mold surface has at least one port and the method further comprises applying a vacuum through the at least one port to assist in conforming the glass-based substrate to the profile of the mold surface.

A tenth aspect according to the ninth aspect, wherein the mold surface comprises at least one flat region and at least one bend region.

An eleventh aspect according to the tenth aspect, wherein the at least one port is not positioned in the at least one bend region.

A twelfth aspect according to any one of the first through eleventh aspects, wherein the mold surface comprises at least one flat region and at least one bend region and the temperature of the at least flat region is lower than the at least one bend region.

A thirteenth aspect according to any one of the first through twelfth aspects, wherein the method also includes clamping a portion of the glass-based substrate against the mold surface.

A fourteenth aspect according to any one of the first through thirteenth aspects, wherein the glass-based substrate has at least one opening extending from a first surface to an opposing second surface.

A fifteenth aspect according to any one of the first through fourteenth aspects, wherein the glass-based substrate is glass or glass-ceramic.

A sixteenth aspect according to any one of the first through fifteenth aspects, wherein the shaping temperature corresponds to a temperature range corresponding to a viscosity of 10⁷ Poise to 10¹¹ Poise.

A seventeenth aspect according to any one of the first through sixteenth aspects, wherein the shaped glass-based article has a three-dimensional cross-section, wherein a first and second portion of the article are coplanar and a third portion of the article located between the first and second portions is not coplanar with the first and second portions and the third portion forms a cavity in the 3D cross-sectional profile between the first and second portions, and an aspect ratio of the width of the cavity to the height of the cavity is about 10 or less.

In an eighteenth aspect, a glass-based article having a first surface having a 3D surface profile; and a second surface opposing the first surface. A thickness between the first and second surfaces varies ±5% or less and the first surface is free of distortions having a height to width ratio greater than 2×10⁻⁴.

A nineteenth aspect according to the eighteenth aspect, wherein the glass-based article may further include at least one opening extending from the first surface to the second surface.

A twentieth aspect according to the eighteenth or nineteenth aspect wherein the glass-based article of is glass or glass-ceramic.

In a twenty-first aspect, a glass-based article having a 3-D cross-sectional profile, wherein a first and second portion of the article are coplanar and a third portion of the article located between the first and second portions is not coplanar with the first and second portions and the third portion forms a cavity in the 3D cross-sectional profile between the first and second portions. An aspect ratio of the width of the cavity to the height of the cavity is about 10 or less.

A twenty-second aspect according to the twenty-first aspect, wherein the first and second portions of the glass-based article are an edge of glass-based shaped article.

A twenty-third aspect according to a twenty-first aspect, wherein the first and second portions form a flange.

A twenty-fourth aspect according to any one of the twenty-first through twenty-third aspects, wherein the glass-based article is glass or glass-ceramic.

In a twenty-fifth aspect, an apparatus for shaping a glass-based substrate. The apparatus may include a mold having a mold surface with a 3D surface profile and a pressure cap that engages the mold surface to provide a pressurized cavity therebetween. The pressure cap may include an orifice for supplying a pressurized gas to the cavity and a baffle positioned over the orifice to direct the flow of the gas into the cavity.

A twenty-sixth aspect according to the twenty-fifth aspect, wherein the mold also includes a clamping cover positioned between the mold surface and the pressure cap to clamp a portion of a glass-based substrate between the clamping cover and the mold surface.

A twenty-seventh aspect according to the twenty-fifth or twenty-sixth aspect, wherein there is only a single orifice.

A twenty-eighth aspect according to any one of the twenty-fifth through twenty-seventh aspects, wherein the mold surface has at least one port connected to a vacuum source.

It is to be understood that both the foregoing general description and the following detailed description are exemplary of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1A is a schematic of a uniform gap between a plunger and mold.

FIG. 1B is a schematic of a non-uniform gap between a plunger and mold.

FIG. 1C is a schematic of a non-uniform gap between a plunger and mold.

FIG. 2A is a cross-section of an exemplary apparatus for forming a 3D glass-based article from a glass-based substrate showing the glass-based substrate positioned therein.

FIG. 2B is a cross-section of the exemplary apparatus of FIG. 2A showing the shaped 3D glass-based article therein.

FIG. 3A is a perspective view of an exemplary 3D glass-based article formed from an oversized glass-based substrate.

FIG. 3B is a perspective view of an exemplary 3D glass-based article formed from a machined 2D preform.

FIG. 4 is a cross-sectional view of an exemplary distortion in the surface of a 3D glass-based article.

FIG. 5 is an exemplary cross-sectional view of a 3D glass-based article.

FIG. 6A is an exemplary cross-sectional view of a 3D glass-based article.

FIG. 6B is an exemplary cross-sectional view of a 3D glass-based article.

FIG. 7 is a perspective view of an exemplary apparatus for shaping a 3D glass-based article from a 2D glass-based substrate.

FIG. 8 is a cross-sectional view of the exemplary apparatus of FIG. 7.

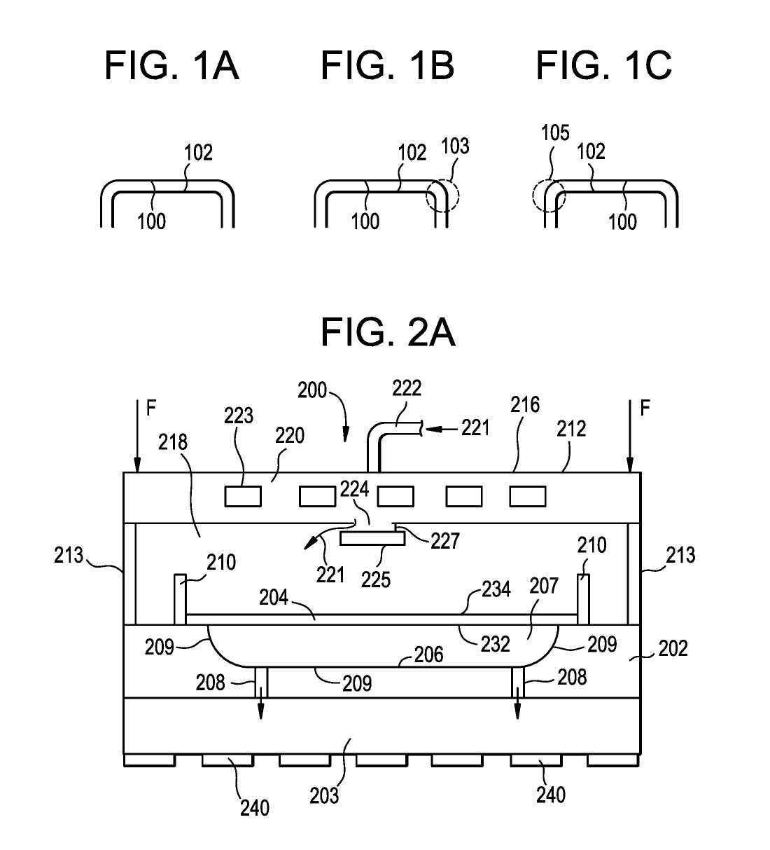

### DETAILED DESCRIPTION

Additional features and advantages of the invention will be set forth in the detailed description that follows and, in part, will be readily apparent to those skilled in the art from that description or recognized by practicing the invention as described herein.

In this specification and in the claims which follow, reference will be made to a number of terms which shall be defined to have the meanings detailed herein.

As used herein, the term “glass-based” includes glass and glass-ceramic materials.

As used herein, the term “substrate” describes a glass-based sheet that may be formed into a three-dimensional structure.

The 3D glass-based articles generally have a non-planar formation. As used herein, the term “non-planar formation” refers to a 3D shape where at least a portion of the glass article extends outwardly or at an angle to a plane defined by the original, laid out configuration of the 2D glass-based substrate. The 3D glass-based articles formed from the glass-based substrates may have one or more elevations or curved portions. The 3D glass-based articles can hold the non-planar formation as a free-standing object, without any external force due to the shaping process.

The disclosure herein generally involves heating a glass-based substrate to a forming temperature and shaping the glass-based substrate in a pressurized sealed environment. Pressurized gas may be used to apply pressure to the glass-based substrate in order to fully conform the glass-based substrate to a 3D surface profile of a mold, thereby forming a shaped glass-based article.

The methods and apparatus disclosed herein offer improvements in throughput, efficiency, uniformity in thickness, and minimizing defects such as orange peel (imprint of irregularities of the mold surface onto the glass-based material) in the shaped glass-based article over two-piece pressing molds and one-piece molds relying on vacuum and/or gravity sagging. For example, a higher throughput of shaped glass-based articles over a period of time may be achieved over shaping methods using a two-piece pressing mold that relies on isothermal heating. Also glass-based substrates can be shaped at a lower forming temperature/higher viscosity using the pressurized sealed environment of the present disclosure because additional pressure is applied to the top of the glass-based material during shaping, which leads to less defects, such as orange peel, than a shaping process using vacuum and/or gravity sagging on a one-piece mold. The use of the pressurized environment may also decrease the time for shaping, and thereby increases throughput.

The methods and apparatus disclosed herein also facilitate making a variety of shapes having minimal distortions and/or wrinkles, including, but not limited to, dish-shaped articles (e.g., an article with a bend around the entire periphery), sled-shaped articles (e.g., a substantially quadrilateral substrate shaped to have bends along two opposing sides), deep-drawn articles (e.g., an article with a bulge having a low width to height aspect ratio), and articles with openings extending through the thickness of the article. In some embodiments, shaping in a pressurized sealed environment may minimize distortions such that the shaped glass-based article is free of distortions having a slope greater than 2×10⁻⁴. In some embodiments, shaping in a pressurized sealed environment may enable forming shaped glass-based articles having a 3D cross-sectional profile wherein a first and second portion of the article are coplanar and a third portion of the article located between the first and second portions is not coplanar with the first and second portions. The third portion forms a cavity in the 3D cross-sectional profile between the first and second portions, and the cavity may have an aspect ratio of width to height of about 10 or less.

### Apparatus

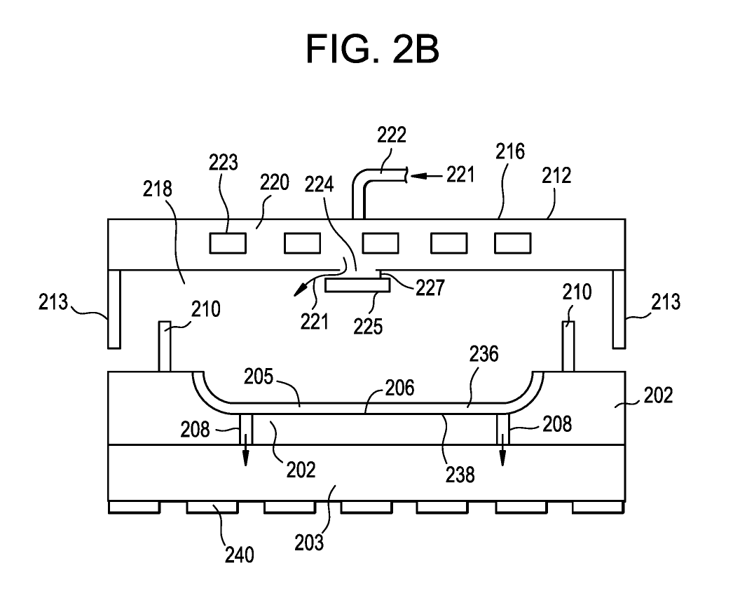

FIG. 2A shows an exemplary apparatus 200 for shaping a 2D glass-based substrate 204 into a 3D glass-based article. The apparatus 200 includes a mold 202 having a mold surface 206. The mold surface 206 has a 3D surface profile that corresponds to the 3D shape of the 3D glass article to be formed. In some embodiments, mold surface 206 is concave and defines a mold cavity 207. In some embodiments, the mold surface 206 may have a flat region 209 and a bend region 211. The 2D glass-based substrate 204 is placed on the mold 202 in a position to sag into the mold cavity 207 or against the mold surface 206. In some embodiments, ports or holes 208 are provided in the mold 202. The ports 208 run from the exterior of the mold 202 to the mold surface 206. In some embodiments, alignment pins 210 may be provided on the mold 202 to assist in aligning the 2D glass sheet 204 with the mold cavity 207.

In some embodiments, the ports 208 may serve as vacuum ports, to apply vacuum to the mold cavity 207, or exhaust ports, to withdraw gas trapped in the mold cavity 207. In embodiments where ports 208 serve as vacuum ports, ports 208 are located in the flat area 209 of mold surface 206 and not in the bend area 211 of the mold surface 206. Such placement only in the flat area 209 may reduce visibility of imprints of the ports on the glass-based substrate 204 and avoid a need to polish away imprints from the ports in bend areas of shaped glass-based article. In such embodiments, ports 208 may be located in a portion of flat area 209 of mold surface 206 adjacent the bend area 211 of the mold surface 206. In other embodiments, ports 208 may be located in the bend area 211 and/or the flat area 209 of mold surface 206. In some embodiments, imprint of ports on glass-based substrate 204 may be minimized by reducing the size of the ports. For example, the ports may be slot-shaped and having a width of about 0.5 mm or less or about 0.25 mm or less, or about 0.125 mm or less.

The mold 202 is made of a material that can withstand high temperatures, such as would be encountered while forming the 3D glass-based article from the glass-based substrate. The mold material may be one that will not react with (or not stick to) the glass-based material under the forming conditions, or the mold surface 206 may be coated with a coating material that will not react with (or not stick to) the glass under the forming conditions. In one embodiment, the mold 202 is made of a non-reactive carbon material, such as graphite, and the mold surface 206 is highly polished to avoid introducing defects into the glass-based material when the mold surface 206 is in contact with the glass-based material. In another embodiment, the mold 202 is made of a dense ceramic material, such as silicon carbide, tungsten carbide, and silicon nitride, and the mold surface 206 is coated with a non-reactive carbon material, such as graphite. In another embodiment, the mold 202 is made of a superalloy, such as Inconel 718, a nickel-chromium alloy, and the mold surface 206 is coated with a hard ceramic material, such as titanium aluminum nitride. In yet another embodiment, the mold 202 is made of nickel including, but not limited commercially pure nickel grades such as nickel 200, nickel 201, nickel 205, nickel 212, nickel 222, nickel 223, or nickel 270. In one embodiment, the mold surface 206, with or without a coating material, has a surface roughness of Ra<10 nm. Use of a carbon material for the mold 202 or use of a carbon coating material for the mold surface 206 will require that the forming of the 3D glass article is carried out in an inert atmosphere.

A pressure cap 212 is mounted on top of the mold 202. The pressure cap 212 has a plenum 216. When the pressure cap 212 is mounted on the top of the mold 202 as shown, for example in FIG. 2A, a pressure chamber 218 is formed between the mold 202 and pressure cap 212. The plenum 216 includes a plenum chamber 220, which is connected via a conduit 222 to a source of pressurized gas 221 (the source is not shown). In some embodiments, the gas is an inert gas, such as nitrogen. The plenum chamber 220 includes an orifice 224 positioned above the mold 202. In some embodiments, orifice 224 is centrally located on a bottom surface plenum chamber 220. In some embodiments, as shown in FIGS. 2A and 2B, there is only a single orifice 224. In other embodiments, there may be more than one orifice 224. In some embodiments, a baffle 225 may partially cover orifice 224. In embodiments, where there is more than one orifice 224, a single baffle 225 may cover some or all of the orifices or there may be more than one baffle 225, for example one baffle 225 for each orifice 224. In some embodiments, one or more posts 227 may extend from baffle 225 to connect it to the bottom surface of the plenum chamber. Gas in the plenum chamber 220 can be directed into the pressure chamber 218 through orifice 224 and baffle 225 towards the mold surface 206. In some embodiments, baffle 225 may be a disk spaced from and partially covering the orifice 224 so that gas can be evenly distributed into pressure chamber 218. In some embodiments, baffle 225 prevents gas from flowing in a straight path from orifice 224 to the surface of the glass-based substrate. In some embodiments, there is only a single orifice 224 from plenum chamber 220 to pressure chamber 218. The pressure cap 212 and baffle 225 should be made of materials that would not generate contaminants under the conditions in which the 2D glass-based substrate 204 will be reformed into a 3D glass-based article. The pressure cap 212 and baffle 225 may be made of the same materials as the mold 202, except that it would not be necessary for the surfaces of the pressure cap 212 and baffle 225 to be highly polished since the glass-based substrate will not come into contact with the surfaces of the pressure cap 212 and baffle 225 during reforming of the glass-based material.

In some embodiments, the pressure chamber 218 between the pressure cap 212 and the mold 202 is sealed before delivering pressurized gas 221 into the pressure chamber 218 through the orifice 224 in plenum 216. The pressure chamber 218 may be sealed by applying a force F to the pressure cap 212 so that a wall 213 of pressure cap 212 clamps down on the top of the mold 202. A ram, or other device capable of applying a force, may be used for this purpose. To maintain the pressure chamber 218 in a sealed condition, the sealing pressure due to application of the force F should be greater than the pressure of the pressurized gas 221 delivered into the pressure chamber 218. In some embodiments, the device for applying force to pressure cap 212 may include a ball joint so that the positioning/alignment of pressure cap 212 against mold surface 206 may be adjusted to provide an adequate seal between pressure cap 212 and mold surface 206.

The mold 202 is placed on a vacuum chuck 203 in some embodiments, as illustrated in FIGS. 2A and 2B. In some embodiments, one or more heaters 240 are arranged below the vacuum chuck 203 to heat the mold 202 and the 2D glass-based substrate 204 placed on the mold 202. If the vacuum chuck 203 is not used, the one or more heaters 240 may simply be arranged below the mold 202. In other embodiments, one or more heaters may be located at pressure cap 212 to heat pressure cap 212 and pressurized gas 221. Heating pressure cap 212 may allow for radiative heating of glass-based substrate 204 directly. In some embodiments, the heaters may be IR heaters positioned to deliver radiative heat to glass-based substrate 204 directly or indirectly through pressure cap 212. The heaters in the pressure cap 212 may be in addition to or in lieu of the heaters 240 arranged below the mold 202 or vacuum chuck 203. In some embodiments, plenum chamber 220 of pressure cap 212 may have one or more heaters 223 distributed therein. The heaters could be any suitable heaters, such as resistive heaters or mid-infrared (mid-IR) heaters, such as Hereaus Noblelight mid-IR heaters.

### Methods

In some embodiments, the shaping process may begin with placing glass-based substrate 204 on mold 202. In some embodiments, glass-based substrate 204 is thin, e.g., has a thickness of about 2 mm or less, about 1.5 mm or less, about 1 mm or less, about 0.7 mm or less, about 0.5 mm or less, about 0.3 mm or less, or about 0.1 mm or less. In some embodiments, glass-based substrate 204 is an ion-exchangeable glass. Ion-exchangeable glasses are alkali-containing glasses with small alkali ions, such as Li⁺, Na⁺, or both. These small alkali ions can be exchanged for larger alkali ions, such as K⁺, during an ion-exchange process. Examples of suitable ion-exchangeable alkali-containing glasses are alkali-aluminosilicate glasses. These alkali-aluminosilicate glasses can be ion-exchanged at relatively low temperatures and to a depth of at least 30 microns.

The alignment pins 210 may be used to precisely locate the glass-based substrate 204 on the mold 202. In some embodiments, glass-based substrate 204 and/or mold 202 may be pre-heated before glass-based substrate 204 is place on mold 202. After placing the glass-based substrate 204 on the mold 202, the glass-based substrate 204 may be heated. In one embodiment, at least the glass-based substrate 204 is heated to a forming temperature, for example to a temperature range corresponding to a viscosity range of 10⁷ Poise to 10¹¹ Poise. In some embodiments, glass-based substrate 204 may be heated to the forming temperature via one or more of the following methods. As described above, glass-based substrate 204 may be heated to the forming temperature via heaters 240 in mold 202. This may occur before, during, or after lowering pressure cap 212 onto mold 202 to create the sealed environment of pressure chamber 218. In some embodiments, glass-based substrate 204 may be preferentially heated to the forming temperature with heaters, such as mid-IR heaters, positioned above mold 202, for example as described in U.S. Pat. No. 9,010,153, which is hereby incorporated by reference in its entirety. In such embodiments, mold 202 may be positioned under the heaters prior to positioning mold 202 under pressure cap 212. Also as described above, glass-based substrate 204 may be heated to the forming temperature via heaters located in pressure cap 212. In such embodiments, the pressure cap 212 may be lowered before, during, or after the heating.

In some embodiments, the glass-based substrate 204 and mold 202 are heated such that they are both at the same temperature by the time the forming of the glass-based substrate 204 into the 3D glass article starts. For this type of heating, the mold 202 may be made of a non-reactive carbon material such as graphite or of a dense ceramic material coated with a carbon coating material. The heating would need to take place in an inert atmosphere. In another embodiment, the glass-based substrate 204 is preferentially heated while on the mold 202 so that the temperature of the mold 202 is lower than that of the glass-based substrate 204, e.g., the temperature of the mold 202 may be 100° C. to 250° C. lower than the temperature of the glass-based substrate 204. A mid-IR heater may be used for this preferential heating. For this preferential heating, the mold 202, as described above, may be made of a superalloy with a hard ceramic coating or may be made of a nickel material. With this material, the preferential heating can take place in a non-inert atmosphere.

In some embodiments, during and/or after heating glass-based substrate 204 to the forming temperature, vacuum may be applied to the mold cavity 207 to draw the bottom surface 232 of the glass-based substrate 204 against the mold surface 206 and seal the glass-based substrate to the mold surface 202. Before vacuum is applied, the glass-based substrate 204 may already have started sagging against the mold surface 206 due to gravity. The vacuum applied may be in a range of up to about 70 kPa or in a range from about 10 kPa to about 40 kPa. In embodiments where vacuum is applied to ports 208, the vacuum may be applied to the mold cavity 207 a few seconds before the pressurized gas 221 is applied to the glass-based substrate. The vacuum may be maintained partially or through the entire duration of applying the pressurized gas 221 to the glass-based substrate, in which case the vacuum can help maintain the position of the glass sheet on the mold surface 206 so that the glass-based substrate does not move when the pressurized gas 221 is being applied. If the starting glass-based substrate 204 is larger than the mold cavity 207 so that it covers the mold cavity 207, then the glass-based substrate may be formed into the 3D glass-based article without use of vacuum. While forming with or without vacuum, the ports 208 in the mold 202 are used to exhaust gas trapped in the mold cavity 207.

In some embodiments, pressure cap 212 may be lowered onto mold 202 to create the sealed environment of pressure chamber 218 above glass-based substrate 204 before, during, or after heating the glass-based substrate 204 depending upon how glass-based substrate 204 is heated to the forming temperature as described above. In some embodiments, pressure cap 212 may be lower onto mold 202 to create the sealed environment of pressure chamber 218 before or after applying vacuum. In some embodiments, once the sealed environment of pressure chamber 218 is created, the pressure in the sealed environment of pressure chamber 218 may be adjusted. In some embodiments, the pressure may be adjusted by supplying pressurized gas 221 through conduit 222 to plenum chamber 220 and out orifice 224 past baffle 225 into pressure chamber 218. In some embodiments, the pressure in pressure chamber 218 may adjusted to be in a range from about 20 psi to about 60 psi. Thus, pressurized gas 221 may provide the pressure needed to fully conform the glass-based substrate 204 to the 3D profile of mold surface 206, thereby completely shaping the 3D glass article.

In some embodiments, pressurized gas 221 may be heated, for example by the heaters 223 located in the pressure cap 212. In some embodiments, pressurized gas 221 may be heated by flowing through channels (not shown) located between and or above heaters 223. In some embodiments, the temperature of the pressurized gas 221 is in the previously mentioned temperature range corresponding to a glass viscosity range of 10⁷ Poise to 10¹¹ Poise. In some embodiments, the temperature of the pressure cap 212 and/or pressurized gas 221 may be at a temperature greater than 800° C., such as between 870° C. and 950° C. so that glass-based substrate is radiatively heated during pressure forming. In some embodiments, the temperature of pressure cap 212 is higher than the temperature of mold surface 206 during shaping, for example the temperature difference between pressure cap 212 and mold surface 206 may be in a range from about 20° C. to about 150° C. Having pressure cap 212 be at a higher temperature than mold surface 206 during shaping may lead to reduced forming time. The temperature of the pressurized gas 221 may be the same as or may be different from the temperature of the glass-based substrate 204. In one embodiment, the temperature of the hot pressurized gas is within 80° C. of the temperature of the glass-based substrate. FIG. 2B shows a 3D glass-based article 205 formed from the glass-based substrate 204 by pressure from the pressurized gas in the sealed environment of pressure chamber 218.

In some embodiments, after forming the 3D glass-based article 205, the flow of pressurized gas 221 to the pressure chamber 218 may be stopped or replaced with flow of colder pressurized gas. Then, the 3D glass-based article 205 is cooled to below the strain point of the glass-based material using or not using colder pressurized gas. The colder pressurized gas may assist in more rapid cooling of the 3D glass-based article 205. In one embodiment, when the colder pressurized gas is used in cooling the 3D glass-based article 205, the temperature of the colder pressurized gas is selected from a temperature range corresponding to the glass transition temperature plus or minus 10° C. In another embodiment, when the colder pressurized gas is used in cooling the 3D glass-based article 205, the temperature of the colder pressurized gas is adjusted to match the temperature of the mold 202 during the cooling. This may be achieved by monitoring the temperature of the mold 202 with sensors such as thermocouples and using the output of the sensors to adjust the temperature of the colder pressurized gas. The pressure of the colder pressurized gas may be less than or the same as the pressure of the hot pressurized gas. The cooling of the 3D glass-based article is such that the temperature difference (delta T) across the thickness of the glass-based article, along the length of the glass-based article, and along width of the glass-based article is minimized. Preferably, delta T is less than 10° C. across the thickness of the glass-based article and along the length and width of the glass-based article. The lower the delta T during cooling, the lower the stress in the glass-based article. If high stress is generated in the glass-based article during cooling, the glass-based article will warp in response to stress. As such, it is desirable to avoid generating high stress in the glass-based article during cooling. The 3D glass-based article 205 can be cooled convectively by applying controlled-temperature gas flow on both sides of the 3D glass-based article 205. Colder pressurized gas, as described above, can be applied to the top surface 236 of the 3D glass-based article 205 through the orifice 224 in plenum chamber 220, and controlled-temperature gas flow, which may have similar characteristics to the colder pressurized gas, can be applied to the bottom surface 238 of the 3D glass-based article 205 through the ports 208 in the mold 202. The pressure of the gas supplied through the ports 208 may be such that a net force is created that lifts the 3D glass-based article 205 from the mold 202 during the cooling. The mold 202 cools at a much slower rate than the glass-based article due to the mold 202 having a larger thermal mass than the glass-based article. This slow cooling of the mold 202 can generate a large delta T across the thickness of the glass-based article. Lifting the glass-based article from the mold 202 during the cooling helps avoid this large delta T.

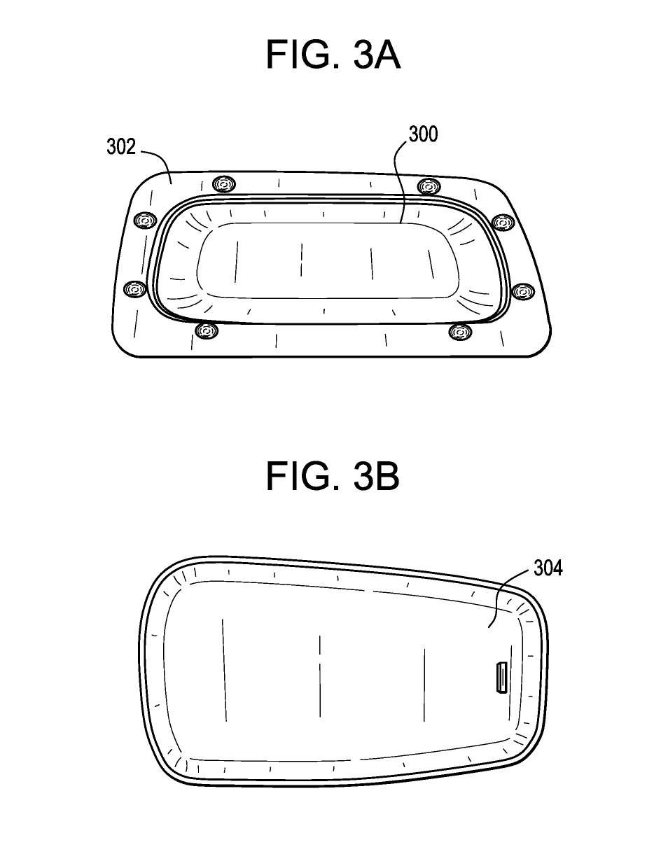

In some embodiments, cooling may be followed by annealing of the 3D glass-based article 205, and annealing of the 3D glass-based article 205 may be followed by an ion-exchange process involving the 3D glass-based article 205. The glass-based substrate 204 used in forming the 3D glass-based article may be an oversized sheet that will be machined to final dimensions after being formed into the 3D glass-based article 205. In this case, the machining can be carried out prior to the ion-exchange process. FIG. 3A shows an example of a 3D glass-based article 300 formed from an oversized glass-based sheet 302. The 3D glass-based article 300 would need to be extracted from the oversized sheet and then edge-finished by suitable machining processes. Alternatively, the glass-based substrate 204 may be a machined 2D preform that needs to be precisely aligned on the mold 202 and that will not be machined after being formed into the 3D glass-based article. The machined preform will have been edge-contoured and edge-finished to the precise shape and size needed for forming the 3D glass-based article. FIG. 3B shows an example of a 3D glass-based article 304 formed from a machined preform. The 3D glass-based article 304 does not require additional edge-finishing.

Gentle contours can be formed at high viscosities, e.g., 10⁹ Poise to 10¹¹ Poise, while tight bends and sharp corners require much lower viscosities, e.g., between 10⁷ Poise and 10^{8.2} Poise. The lower viscosities allow the glass-based substrate to better conform to the mold. However, it is challenging to achieve good glass-based surface cosmetics at low viscosities because it is easier to imprint defects on the glass-based surface. Forming at low viscosities can cause glass reboil, which generates orange peel. The vacuum or exhaust ports in the mold surface are easily imprinted in the glass-based material at lower glass viscosities. On the other hand, it is easier to achieve good surface cosmetics high viscosities. Thus, to achieve both good glass-based surface cosmetics and tight dimensional tolerances in the 3D glass-based article, as well as increased throughput, the pressure applied to the glass-based substrate by the pressurized gas, the viscosity of the glass-based substrate, and placement and size of vacuum ports are factors to consider As discussed above, the methods and apparatus disclosed offer improvements in throughput, efficiency, and minimizing defects such as orange peel in the shaped glass-based article over two-piece pressing molds and one-piece molds relying on vacuum and/or gravity sagging.

There are several options available for obtaining tight dimensional tolerances while maintaining good glass surface cosmetics.

One option is to use contour correction in the mold. For example, for forming 3D shapes with tight bends, the mold can be designed with walls at a tighter bend radius and steeper sidewall tangent angle than the final shape. For example, if the sidewall tangent angle of a dish to be formed is 60°, and if it is desired to form the dish at log viscosity of 9.5 P to maintain good glass surface cosmetics, then the forming process may produce a dish with sidewall tangent angle of 46°, i.e. 14° less than the desired angle, if the mold contour is not corrected. To increase the sidewall tangent angle, without lowering glass viscosity, the mold contour can be compensated to increase the sidewall tangent angle by the difference between the ideal shape and the measured angle on the formed article. In the above example, the compensated mold would have a sidewall tangent angle of 74°. It is possible to do this contour correction and achieve a glass-based article with uniform thickness because there is no gap between a plunger and mold to worry about, since the pressure needed to form the shape is being provided by the pressurized gas.

Another option is to use a high degree of polish on the mold that would allow for lowering the glass viscosity without creating defects on the glass surface. The mold surface can be made to have a surface roughness of Ra<10 nm and can be made to be non-sticky or non-reactive. For example, a glassy graphite coating may be used on the mold surface.

Another option is to use a cold mold/hot glass arrangement, where the mold is 100° C. to 250° C. cooler than the glass-base material being formed.

Yet another option is to use heaters to preferentially heat the glass-based substrate corresponding to the area that will contact the bend area 211 of mold surface 206(the “3D area”, i.e., the area to be formed into a 3D shape including any combination of bends, corners, and curves). For example, the glass-based in the 3D area may be heated 10-30° C. higher than the glass in the 2D area (i.e., the remaining area that will not be formed into a 3D shape) of the glass-based material. The heaters may be placed above the glass-based substrate or in the mold.

### Articles

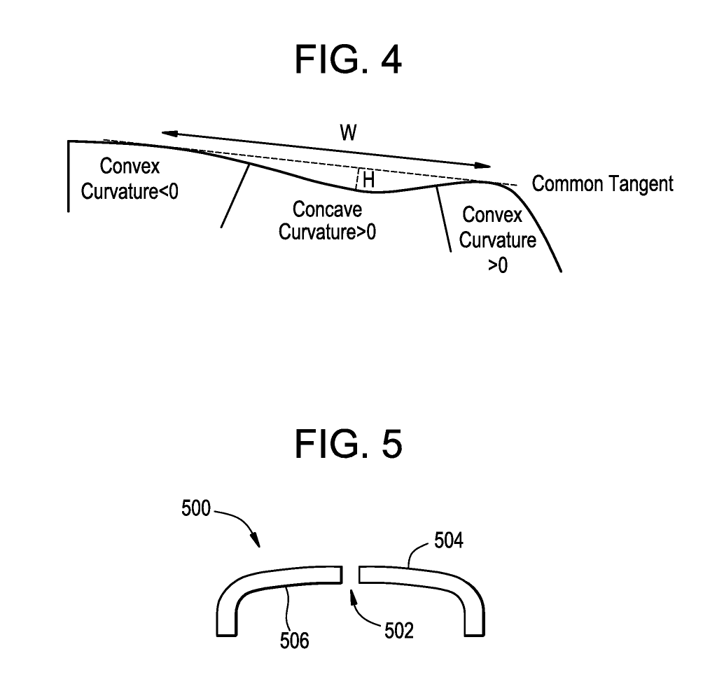

In some embodiments, the shaped 3D glass-based articles formed according to the methods and apparatus disclosed herein have an improved distortion quality. A distortion in a glass surface occurs when the curvature of the glass surface cross-section changes signs (i.e., positive to negative to positive or negative to positive to negative) over a region that has a convex-concave-convex transition or a concave-convex-concave transition. A distortion may be identified by examination of the surface under a grid-light. A grid-light is a light-source having a mesh imprinted on it. When the glass-based article is placed on a dark background and viewed under the grid light at non-normal angles, a distortion may be identified as a discontinuous change in light reflection in that the reflection of the grid-lines are distorted in areas of curvature change. The severity of a distortion may be quantified by measuring the height to width ratio of the distortion. The surface of a glass-based article may be measured using any commercially available surface profilometer, either contact or non-contact, to identify distortions and calculate the height to width ratio of the distortion. FIG. 4 illustrates a distortion comprising a change in curvature having a convex-concave-convex transition. The distortion may have a height H and a width W. A tangent line may be drawn across the change in curvature. The height H is the greatest distance measured from the tangent line to the surface with using a line perpendicular to the tangent line. The width W is measured as the distance along the tangent line measured from the points of contact of the tangent line with the surface. Once the width and length of a distortion are measured the ratio of the height to width may be calculated by dividing the height by the width. In some embodiments, the shaped glass-based article may be free of distortions having a height to width ratio greater than 2×10⁻⁴ along any cross-section of the distortion.

In some embodiments, the shaped glass-based article free of distortions having a height to width ratio greater than 2×10⁻⁴ may have one or more openings formed therein and/or may be sled shaped. FIG. 5 shows a cross-sectional view of an exemplary sled-shaped glass-based article 500 having an opening 502 extending from a first surface 504 to an opposing second surface 506. Shaping a glass-based substrate with such an orifice in a pressurized sealed environment may reduce distortion surrounding the orifice compared to shaping using vacuum alone. This is because when relying on vacuum alone to shape the glass-based substrate the vacuum will be pulling air through the orifice making it difficult to hold the substrate in place against the mold surface. It is believed that the pressurized sealed environment will minimize/eliminate this problem. Similarly shaping a glass-based substrate into a sled-shape in a pressurized sealed environment may reduce distortion surrounding the two sides of the glass-based substrate that are not curved compared to shaping using vacuum alone. Again this is because when relying on vacuum alone to shape the glass-based substrate, the vacuum will pull air through the two ends that are not curved making it difficult to shifting because the glass-base substrate will not be able to hold the substrate in place against the mold surface.

In some embodiments, the shaped 3D glass-based articles formed according to the methods and apparatus disclosed herein have a first surface and an opposing second surface wherein a thickness between the first and second surfaces varies ±5% or less. This may be achieved as a result of uniform pressure being applied to the glass-based substrate during shaping in the pressurized sealed environment of the pressure chamber.

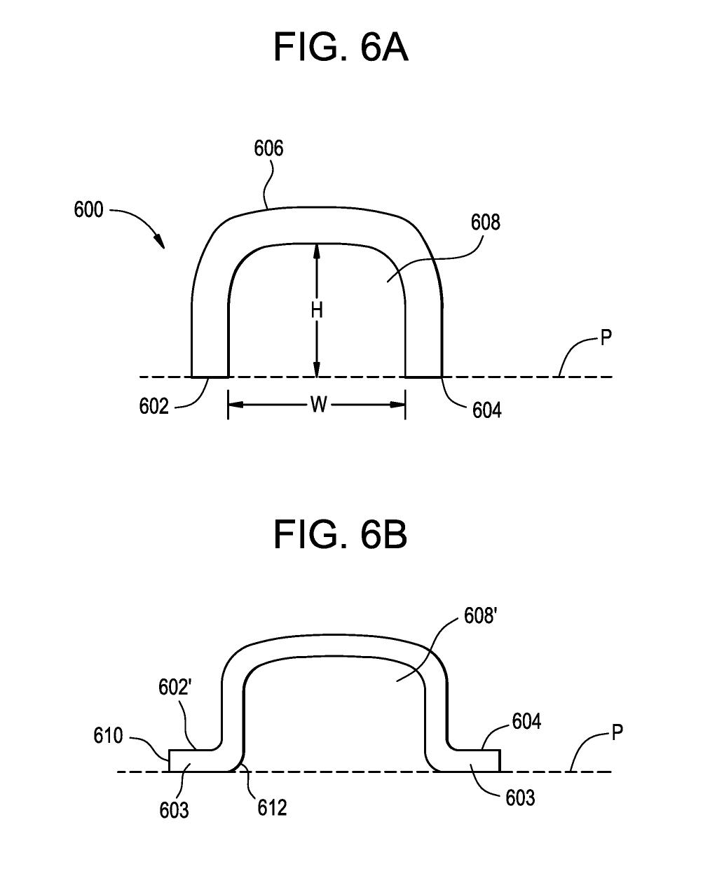

In some embodiments, as shown for example in FIG. 6A, a shaped glass-based article 600 may have a first portion 602 and second portion 604 that are coplanar and a third portion 606 located between the first and second portions 602, 604 that is not coplanar with the first and second portions. In some embodiments, third portion 606 may a cavity 608 in the 3D cross-sectional profile between the first and second portions 602, 604. The cavity 608 may have a variety of shapes, including but not limited to, substantially hemispherical, substantially cylindrical, and substantially half of an oval. The cavity 608 may have a height H and a width W and an aspect ratio of width to height. The height may be measured as the greatest distance between a plane P of first and second portions 602, 604 and the end of cavity 608 opposite plane P measured along a line perpendicular to the plane P. The width may be the shortest distance between first portion 602 and second portion 604 across cavity 608. The aspect ratio of width to height may be calculated by dividing the width by the height. In some embodiments, the cavity 608 has an aspect ratio of width to height of about 10 or less, about 9 or less, about 8 or less, about 7 or less, about 6 or less, about 5 or less, about 4 or less, or about 3 or less. In some embodiments, as shown in FIG. 6A first and second portions 602, 604 may form an edge of glass-based shaped article 600. In other embodiments, as shown for example in FIG. 6B, first and second portions 602′, 604′ may form a flange 603 having an outer perimeter 610 and an inner perimeter 612 and cavity 608′ may extend outward from inner perimeter 612.

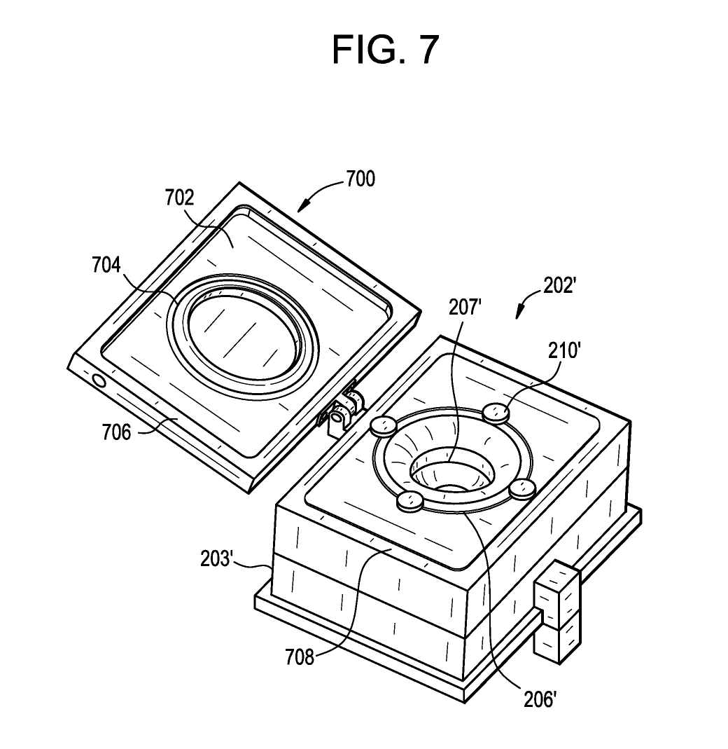

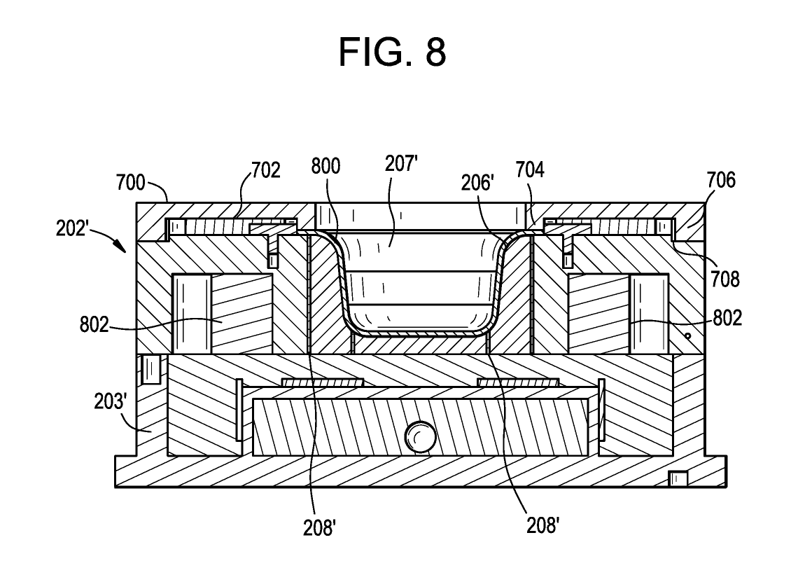

In some embodiments, the mold may be modified when shaping to form a glass-based article having a flange and a cavity extending therefrom as described above, for example with respect to FIG. 6B. FIG. 7 illustrates a perspective view of such an exemplary mold 202′ and FIG. 8 illustrates a cross section view of such the exemplary mold 202′. Mold 202′ is similar to mold 202 described above with respect to FIGS. 2A and 2B. Parts of mold 202′ similar to mold 202 will use the same numeral but with a “” after the numeral and will not be described again in detail. Parts of mold 202′ that do not have a corresponding feature will be designated by numerals starting with 7 or 8. Mold 202′ has a mold surface 206′, a mold cavity 207′, ports 208′, vacuum chuck 203′ and alignment pins 210′. As shown in FIG. 6B, a glass-based article shaped in mold 202′ will have a flange around an outer periphery and a cavity extending outward from a plane of the flange. A glass-based substrate that is to be formed in mold 202′ will be placed on mold 202′ so that the edges abut alignment pins 210′. A clamping cover 700 may be used to clamp the glass based substrate around the periphery during forming. Clamping cover 700 may have an inner surface 702 with a ridge 704 extending from surface 702 that has a shape corresponding to a periphery of the glass-based substrate to be shaped. In FIGS. 7, the ridge 704 is shown as being circular, but this is merely exemplary. The glass-based substrate and the ridge 704 may have alternative shapes, such as oval, elliptical, quadrilateral, etc. Inner surface 702 may also have a ridge 706 the extends therefrom along a periphery of the cover. Mold surface 206′ may have a groove 702 around a periphery of mold surface 206′ so that when clamping cover 700 is place on mold 202′as shown in FIG. 8, ridge 706 sits in groove 708 and ridge 704 clamps a periphery of the glass-based substrate 800 against mold surface 206′. Ridge 706 and groove 708 are shown in FIGS. 7 and 8 as being at the periphery of inner surface 702 and mold surface 206′, respectively, but this is merely exemplary. Ridge 706 and/or groove 708 may alternatively be spaced in inward from a periphery of inner surface 702 and mold surface 206′, respectively. As shown in FIG. 8, ridge 704 clamps the periphery of glass-based substrate 800 in an area that ultimately forms the flange of the shaped glass-based article when clamp cover 700 is placed on mold surface 206′. The clamping function of ridge 704 also pins the periphery of glass-based substrate 800 in place so that it does not move when the remainder of the glass-based substrate is drawn into mold cavity 207′and prevents or minimizes the presence of wrinkles in the flange of the shaped glass-based article. In some embodiments, an interior of mold 202′ has one or more cavities 802 that provide a cooling function for mold 202′.

The process for shaping a glass-based substrate using the apparatus described above and illustrated in FIGS. 7 and 8, is similar to the process described above for shaping using the apparatus described with reference to FIGS. 2A and 2B with the addition that clamp cover 700 is placed over mold surface 206′ to clamp the glass-based substrate between ridge 704 and mold surface 206′. Clamp cover 700 is positioned in place to clamp the glass-based substrate prior to heating the glass-base substrate to a forming temperature and/or prior to applying vacuum through ports 208′. The same pressure cap 212 described and illustrated with reference to FIGS. 2A and 2B may be placed over clamping cover 700 to create the sealed pressure chamber above the glass-based substrate. Clamping cover 700 may be attached to mold surface 206′ via a hinge or may be a separate discrete piece.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of shaping a glass-based substrate, the method comprising:
(a) placing a glass-based substrate on a mold having a mold surface with a 3D surface profile;
(b) heating the glass-based substrate to a shaping temperature;
(c) creating a sealed environment above the glass-based substrate; and
(d) adjusting the pressure in the sealed environment with a pressurized gas to conform the glass-based substrate to the profile of the mold surface to create a shaped glass-based article, wherein the shaped glass-based article is free of distortions having a height to width ratio greater than 2×10 ⁻⁴.

2. The method of claim 1, wherein creating the sealed environment comprises placing a pressure cap assembly over the mold, wherein the pressure cap comprises:
an orifice for supplying the pressurized gas; and
a baffle positioned over the orifice to direct the flow of the gas.

3. The method of claim 2, further comprising heating the pressure cap assembly to radiatively heat the glass-based substrate.

4. The method of claim 2, wherein the temperature of the pressure cap is higher than the temperature of the mold surface.

5. The method of claim 4, wherein a temperature difference between the pressure cap and the mold surface is in a range from about 20° C. to about 150° C.

6. The method of claim 2, wherein there is only a single orifice.

7. The method of claim 1, wherein the pressurized gas is heated.

8. The method of claim 1, wherein the sealed environment is adjusted to a pressure in a range from about 20 psi to about 60 psi.

9. The method of claim 1, wherein the mold surface has at least one port and the method further comprises applying a vacuum through the at least one port to assist in conforming the glass-based substrate to the profile of the mold surface.

10. The method of claim 9, wherein the mold surface comprises at least one flat region and at least one bend region.

11. The method of claim 10, wherein the at least one port is not positioned in the at least one bend region.

12. The method of claim 1, wherein:
the mold surface comprises at least one flat region and at least one bend region; and
the temperature of the at least flat region is lower than the at least one bend region.

13. The method of claim 1, further comprising clamping a portion of the glass-based substrate against the mold surface.

14. The method of claim 1, wherein the glass-based substrate has at least one opening extending from a first surface to an opposing second surface.

15. The method of claim 1, wherein the glass-based substrate is glass or glass-ceramic.

16. The method of claim 1, wherein the shaping temperature corresponds to a temperature range corresponding to a viscosity of 10⁷ Poise to 10¹¹ Poise.

17. The method of claim 1, wherein the shaped glass-based article has a three-dimensional cross-section, wherein:
a first and second portion of the article are coplanar and a third portion of the article located between the first and second portions is not coplanar with the first and second portions and the third portion forms a cavity in the 3D cross-sectional profile between the first and second portions, and
an aspect ratio of the width of the cavity to the height of the cavity is about 10 or less.

18. A glass-based article comprising:
(a) a first surface having a 3D surface profile; and
(b) a second surface opposing the first surface,
wherein a thickness between the first and second surfaces varies ±5% or less, and
wherein the first surface is free of distortions having a height to width ratio greater than 2×10⁻⁴.

19. The glass-based article of claim 18, further comprising at least one opening extending from the first surface to the second surface.

20. The glass-based article of claim 18, wherein the article is glass or glass-ceramic.

21. A glass-based article comprising a 3-D cross-sectional profile, wherein:
a first and second portion of the article are coplanar and a third portion of the article located between the first and second portions is not coplanar with the first and second portions and the third portion forms a cavity in the 3D cross-sectional profile between the first and second portions, and
an aspect ratio of the width of the cavity to the height of the cavity is about 10 or less.

22. The glass-based article of claim 21, wherein the first and second portions are an edge of glass-based shaped article.

23. The glass-based article of claim 21, wherein the first and second portions form a flange.

24. The glass-based article of claim 21, wherein the article is glass or glass-ceramic.

25. An apparatus for shaping a glass-based substrate, the apparatus comprising:
a mold having a mold surface with a 3D surface profile; and
a pressure cap that engages the mold surface to provide a pressurized cavity therebetween, wherein the pressure cap comprises:
an orifice for supplying a pressurized gas to the cavity; and
a baffle positioned over the orifice to direct the flow of the gas into the cavity.

26. The apparatus of claim 25, wherein the mold comprises a clamping cover positioned between the mold surface and the pressure cap to clamp a portion of a glass-based substrate between the clamping cover and the mold surface.

27. The apparatus of claim 25, wherein there is only a single orifice.

28. The apparatus of claim 25, wherein the mold surface has at least one port connected to a vacuum source.
